(19) United States
(12) Patent Application Publication
(10) Pub. No.: US 2007/0223224 A1
(43) Pub. Date: Sep. 27, 2007

(54) Illuminated privacy screen

(76) Inventor: Daniel Edelist, Venice, CA (US)

Correspondence Address: DANIEL EDELIST, 6323 MAYWOOD AVENUE, HUNTINGTON PARK, CA, 90255, US

(21) Appl. No.: 11/389,473

(22) Filed: Mar. 27, 2006

(51) Int. Cl. F21V 23/02

(52) U.S. Cl. 362/260

(57) ABSTRACT

Illuminated privacy screen with a rigid rectangular frame constructed of inwardly facing U shaped frame members, a pair of fluorescent light bulbs, a pair of translucent screen members each capable of filling each side of the entire rectangular frame, a screen supporting base, a power cord and attached plug, an on/off switch, the light bulbs each mounted longitudinally inside the right and left the U shaped channels respectively, the rectangular frame mounted to the base, the bulbs wired to the power cord and attached plug, so that when the user inserts the power plug into a standard 120 volt AC wall socket and turns on the switch, the translucent screen members are illuminated relatively evenly along their entire surface. The base portion includes a tip resistant metal plate

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of portable privacy screens and more specifically to an illuminated privacy screen.

Within the realm of interior design of living spaces, it is sometimes necessary to create smaller living or working spaces within a larger room. To this end, furniture designers have developed a variety of portable privacy screens that can be set up in a room to separate one space from another. Privacy partitions a common feature in office environments. For the home environment one can purchase a privacy screen comprised of a plurality of hinged panels of opaque or translucent material. The panels are placed in a zig zag fashion so that they are self supporting. Additionally, a single panel having an attached base plate can be used as a privacy screen.

Privacy screens are currently constructed out of a variety of materials including wood, metal, or plastic. Many privacy screens are constructed so that there is a rigid frame structure filled with a less rigid interior panel made of such materials as fabric, and even paper.

Although the current designs for privacy screens are adequate in creating smaller spaces from a large space, they do not offer the ability to also illuminate the resulting smaller space.

### BRIEF SUMMARY OF THE INVENTION

The primary object of the invention is to provide a privacy screen that is illuminated.

Another object of the invention is to provide an illuminated privacy screen that is free standing.

Another object of the invention is to provide an illuminated privacy screen whose illumination source is hidden.

A further object of the invention is to provide an illuminated privacy screen that has a thin profile.

Yet another object of the invention is to provide an illuminated privacy screen that provides an evenly illuminated panel on both the front and back of the screen.

Still yet another object of the invention is to provide an illuminated privacy screen that is self supporting and tip resistant.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an illuminated privacy screen comprising: a rigid rectangular frame constructed of inwardly facing U shaped frame members, a pair of F28W/T5/830 or similar fluorescent light bulbs, a pair of translucent screen members each capable of filling each side of the entire rectangular frame, a frame and screen supporting base, a power cord and attached plug, an on/off switch, said light bulbs each mounted longitudinally inside the right and left said U shaped channels respectively, said rectangular frame mounted to said base, said bulbs wired to said power cord and attached plug, so that when the user inserts said power plug into a standard 120 volt AC wall socket and turns on said switch, said translucent screen members are illuminated relatively evenly along their entire surface.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a front view of the invention.

FIG. 2 is a side view of the invention.

FIG. 3 is a side section view of the invention.

FIG. 4 is a top view of the invention.

FIG. 5 is a top section view of the invention.

### DETAILED DESCRIPTION OF THE PREFERRED EMBODIMENTS

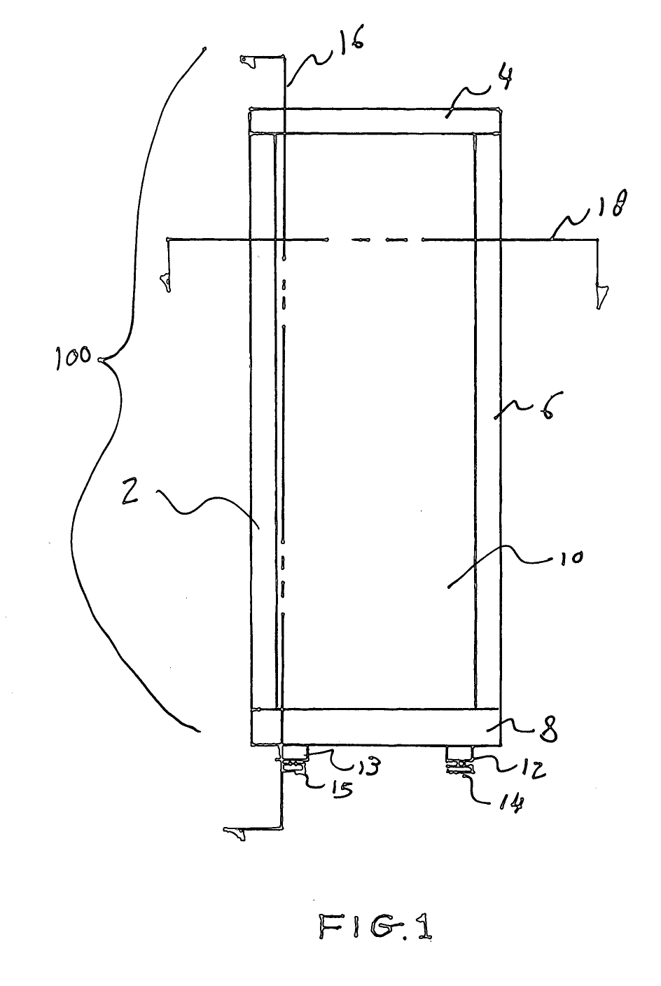

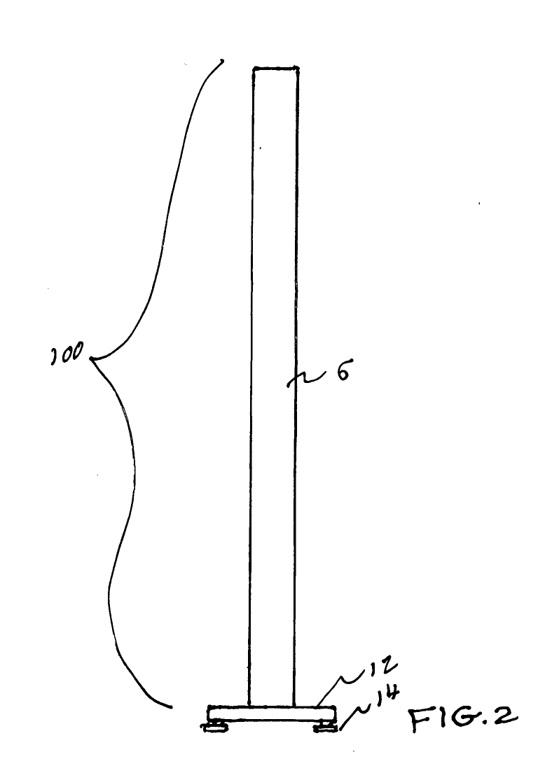

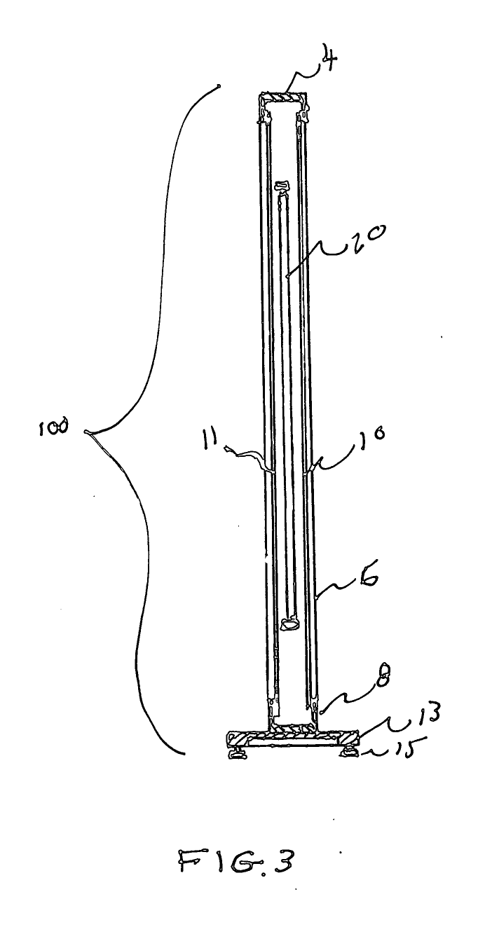

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Referring now to FIG. 1 we see a front view of the present invention 100. A rigid frame 2, 4, 6, 8, is supported by base plates 12, 13. Self leveling feet 14, 15 attached to the undersides of base plates 12, 13. A translucent panel 10 fills the space inside the frame members 2, 4, 6, 8. The height of the privacy screen 100 is approximately seventy two inches. The width is approximately twenty-seven inches. The rear view of the invention is the same configuration of the front view and includes identical screen 11 as shown in FIG. 3. FIG. 2 is a side view of the present invention 100. The thickness of vertical frame member 6 can be between one inch and six inches. The opposite side view is the same configuration as the view shown in FIG. 2. FIG. 3 is a side section view 16 of the present invention 100. The frame members 2, 4, 6, 8 are U shaped. A thin fluorescent bulb 20 is recessed inside U shaped member 2. The bulb is am F28W/T5/830 type bulb and is approximately five eighths of an inch in diameter, which much thinner than traditional fluorescent bulbs used in ceiling fixtures. Because of the thinness of the bulb 20, the overall thickness of the frame 2, 4, 6, 8 can be as little as one inch. The translucent screen members 10, 11 are mounted onto the inside surface of the U shaped frame 2, 4, 6, 8. The screen is preferably constructed of a laminated layer of fabric and translucent styrene sheet. Because the bulbs 20, 21 are mounted inside the U shaped frame members 2, 6, the fabric used in the screen can be quite thin because there is no danger of hot spots which would occur if the bulbs were mounted directly behind the fabric, as is traditional with standard back lit signage. Standard back lit signs require a significantly thicker housing from front to back as well as thicker translucent material to reduce the hot spot effect.

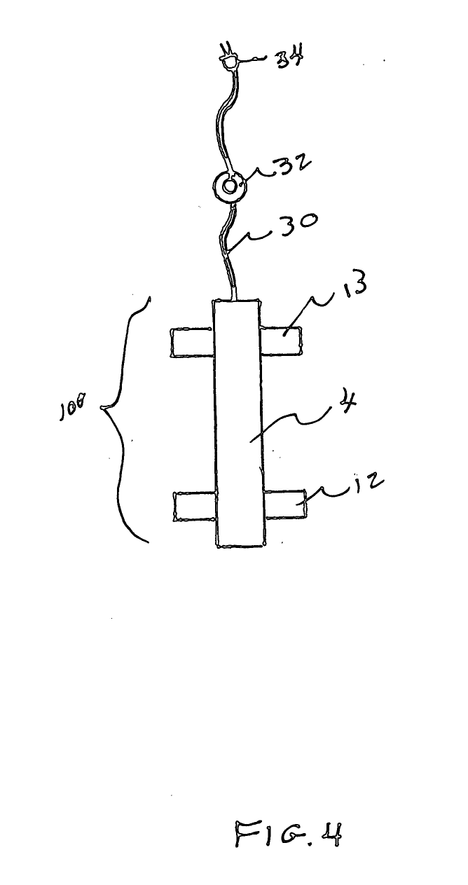

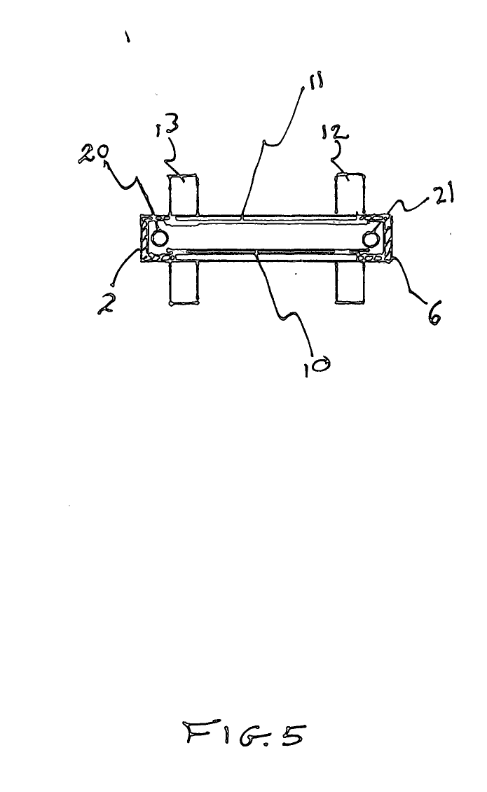

Therefore the placement of the bulbs 20, 21 is critical to the visual success of the invention 100. FIG. 4 is a top view of the invention 100. Base plates 12, 13 can be clearly seen and are wide enough to support the attached frame 2, 4, 6, 8. The base plates 12, 13 include heavy metal plates to help decrease the chance of the invention tipping over. FIG. 5 is a top section view of the invention 100 clearly showing the placement of fluorescent bulbs 20, 21. The bulbs 20, 21 are clearly recessed into vertical frame members 2, 6. The present novel invention allows a portable privacy screen to be illuminated evenly on both sides and yet have a relatively thin profile with the translucent screens having no visual hot spots.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Illuminated privacy screen comprising:
a rigid rectangular frame constructed of inwardly facing U shaped frame members;
a pair of F28W/T5/830, or similar sized fluorescent light bulbs;
a pair of translucent screen members each capable of filling each side said entire rectangular frame;
a screen supporting base;
a power cord and attached plug;
an on/off switch;
said light bulbs each mounted longitudinally inside the right and left said U shaped channels respectively;
said rectangular frame mounted to said base;
said bulbs wired to said power cord and attached plug;
so that when the user inserts said power plug into a standard 120 volt AC wall socket and turns on said switch, said translucent screen members are illuminated relatively evenly along their entire surface.

2. Illuminated privacy screen as claimed in claim 1 wherein said base portion includes a heavy metal plate adding stability to said base and said attached screen.

3. Illuminated privacy screen as claimed in claim 1 wherein said base includes standard leveling feet.

4. Illuminated privacy screen as claimed in claim 1 wherein said frame is approximately seventy-two inches tall, twenty-seven inches wide and between one and six inches thick.

5. Illuminated privacy screen as claimed in claim 1 wherein the leg dimension of the U of said U shaped channel is approximately five inches and the base dimension of said U shaped channel is between one inch and six inches.
